(19) United States
(12) Patent Application Publication
(10) Pub. No.: US 2023/0217955 A1
(43) Pub. Date: Jul. 13, 2023

(54) MODIFIED LUPIN PROTEIN

(71) Applicant: Curtin University of Technology, Bentley (AU)

(72) Inventors: Stuart Johnson, Lesmur-die (AU); Hayder Abdulzahra Abdulmahdi Al-Ali, Bentley (AU)

(21) Appl. No.: 17/922,951

(22) PCT Filed: May 4, 2021
(86) PCT No.: PCT/AU2021/050409

§ 371 Date: Nov. 2, 2022

(30) Foreign Application Priority Data
May 4, 2020 (AU) AU2020901406

(51) Int. Cl. A23J 1/14; A23J 3/14; A23L 3/36

(52) U.S. Cl. CPC A23J 1/146; A23J 3/14; A23L 3/36

(57) ABSTRACT

This disclosure relates generally to lupin protein, and more specifically to modifying lupin protein to improve its use as a protein feedstock, for example in food processing. Provided herein is a method of forming a protein feedstock comprising modified lupin protein that has a decreased thermal stability compared to unmodified lupin protein, the method comprising providing a solution of lupin protein, passing ultrasound waves through the solution of lupin protein in a manner to form the modified lupin protein and collecting the modified lupin protein. Also provided is a protein feedstock comprising modified lupin protein, the modified lupin protein having a decreased thermal stability compared to unmodified lupin protein, wherein the modified lupin protein is formed by subjecting unmodified lupin protein to ultrasound waves, as well as compositions and food products comprising the protein feedstock.

### TECHNICAL FIELD

This disclosure relates generally to lupin protein, and more specifically to modifying lupin protein to improve its use as a protein feedstock, for example in food processing.

### BACKGROUND

There is growing interest in plant legume protein for use as a food ingredient. Nutritional value and functional properties are generally the most important properties in any plant protein sources for use as food ingredients. Lupin protein has great potential to substitute animal protein sources in mainstream food industry due to high nutritional value and low anti-nutritional factor content. Lupin kernels are around 40% by weight in protein with a reasonable balance of essential amino acids such as sulphur amino acids.

Despite the promise of lupin protein, it remains underutilised as a food ingredient because of some difficulties in processing. For example, its lack of gelation properties prevents it from being using in some food applications. Protein gels can be formed by heating, aggregating and gelation. These three steps occur simultaneously on heat-set gels while gelation steps can be separated from the two previous steps in cold-set gel systems. Separation of the gelation steps may be done by controlling gelation conditions, such as protein concentration and pH, in which case the gels form at lower (cool) temperatures rather that high temperatures. Cold-set gels can be useful for wide range of applications such as processing foods containing heat sensitive bio-active ingredients. Protein gels are a cross-linked polymer network, which is formed from unfolded and aggregated strands of protein. Protein gelation is considered as being complex due to the wide range of factors controlling the process, such as protein type, protein concentration, pH, ionic strength and thermal treatment temperature/time.

Lupin proteins have very weak gelation properties compared to animal and certain legume proteins such as soybean and pea proteins. It has been reported that lupin protein has higher thermal stability than that from soybean due to a higher number of disulphide groups. The thermal stability of lupin protein may prevent it from denaturing and aggregating which is the determining gelation step in forming hot- or cold-set gels. These properties of lupin protein make it unsuitable for use in the food processing industry when gel like properties are required.

Due to this lack of desirable gel-forming property, little attention has been given to the use of lupin-based protein and the formation the lupin-based gels. Instead, attention has been focused on protein feedstocks and proteins derived from soybean. Soybean protein is very well understood and now accounts for a large portion the market for vegetable-based proteins. On the other hand, there is presently an opportunity to better understand how to better utilise lupin protein.

A problem with vegetable-based protein sources is that the required growing conditions of the plants means that they cannot be grown in all geographic locations, which can present food security issues for nations that are net importers of vegetable-based protein. Certain plant-based protein sources such as soybean, for example, require higher amounts of water. On the other hand, lupin has less water requirements and is better suited for production in Mediterranean climates.

It is to be understood that, if any prior art publication is referred to herein, such reference does not constitute an admission that the publication forms a part of the common general knowledge in the art, in Australia or any other country.

### SUMMARY

The disclosure provides in an embodiment a method of forming a protein feedstock comprising modified lupin protein that has a decreased thermal stability compared to unmodified lupin protein, the method comprising: providing a solution of lupin protein; passing ultrasound waves through the solution of lupin protein to form the modified lupin protein in a manner such that the thermal stability of the modified lupin protein is decreased compared to unmodified lupin protein; and collecting the modified lupin protein.

Disclosed in an embodiment is a method of forming a protein feedstock comprising modified lupin protein that has a decreased thermal stability compared to unmodified lupin protein, the method comprising: providing a solution of lupin protein; passing ultrasound waves through the solution of lupin protein in a manner to form the modified lupin protein; and collecting the modified lupin protein.

The term “protein feedstock” is to be understood to mean a source of protein that is used in one or more further processes to form other products, such as in the food industry. The term “protein feedstock” may also be used interchangeably with “edible feedstock”. For example, the method may be used to provide a modified lupin protein source that is used to form protein gels that are used, for example, in the manufacture of meat-substitute products or in food texturizing applications.

The modified lupin protein of an embodiment may have an increased proportion of β-sheets compared to unmodified lupin protein.

The ultrasound waves may be generated from a sonicator. In some embodiments, the ultrasound waves are suitably high-intensity ultrasound waves. The frequency of the ultrasound may be within the range of about 20 kHz to about 100 kHz. In preferred embodiments the frequency is about 20 kHz (i.e. 20+/−5 kHz, or +/−2 kHz, or +/−1 kHz). The high-intensity ultrasound waves may in some embodiments have a power within the range of about 5 W/cm² to about 50 W/cm². A temperature of the solution of lupin may be maintained below about 35° C. when subjected to ultrasound waves. It should be appreciated that although the solution in the bulk may remain below about 35° C., in the cavitation zone the temperatures may be significantly higher than 35° C.

The solution of lupin protein may be subjected to ultrasound waves for a period of 60 minutes or less. The solution of lupin protein may have a protein concentration of about 0.1% (w/w) to about 40% (w/w), such as about 5% (w/w) to about 20% (w/w) including concentrations such as about 10% (w/w). Solids, such as crude native protein, that are used to form the solution of lupin protein may be a lupin protein concentrate, i.e. have a lupin protein content>35%. In some embodiments, the lupin protein used to form the solution of lupin protein may have a purity (i.e. lupin protein content)>70%. In some embodiments, the lupin protein concentrate may be a lupin protein isolate having a purity>90%. The solution of lupin protein may have a pH of approximately 7.0, for example 7.0±0.5 or 7±0.1, when subjected to ultrasound waves. In an embodiment, the method may further comprise a purification step to purify the solution of lupin protein and/or to purify the modified lupin protein.

In an embodiment, after forming the modified lupin protein, the method may further comprise: adjusting a pH of a solution comprising the modified lupin protein to an isoelectric point of the modified lupin protein; and heating the solution comprising the modified lupin protein to a temperature to induce aggregation of the modified lupin protein and then cooling the solution comprising the modified lupin protein to form a gel.

The modified lupin protein may be collected as the gel. The isoelectric point may be approximately pH 4.5 (i.e. ±0.5, preferably ±0.1). The solution comprising the modified lupin protein may be heated above 70° C. The solution comprising the modified lupin protein may be maintained at the temperature to induce aggregation of the modified lupin protein for less than 60 minutes. In an embodiment, the solution comprising the modified lupin protein may be maintained at the temperature to induce aggregation of the modified lupin protein for approximately 20 minutes. After heating the solution comprising the modified lupin protein to the temperature to induce aggregation of the modified lupin protein, the solution comprising the modified lupin protein may be cooled below about 70° C., such as cooling to room temperature, to form the gel. A maximum temperature reached during heating may be approximately 95° C. The method may further comprise dehydrating the gel. An embodiment may further comprise forming a solution of modified lupin protein prior to adjusting the pH of the solution comprising the modified lupin protein to the isoelectric point of the modified lupin protein.

The modified lupin protein may be collected as a powder. The modified lupin protein may be collected as a modified lupin protein concentrate or isolate.

The disclosure also provides a protein feedstock comprising modified lupin protein prepared using the method as set forth above.

The disclosure also provides a protein feedstock comprising modified lupin protein, the modified lupin protein having a decreased thermal stability compared to unmodified lupin protein. The modified lupin protein is formed by subjecting unmodified lupin protein to ultrasound waves.

The modified lupin protein may have an increased proportion of β-sheets compared to unmodified lupin protein. The protein feedstock may have a purity of modified lupin protein (i.e. protein content based on the modified lupin protein) of >35%, such as about >70%. In the present description, compositions containing a protein content>35% are referred to generally as “concentrates”, and compositions containing a protein content of 90% or more are referred to as “isolates”. Some concentrates with a higher concentration of protein may have a protein content of at least 70% (about >70%). Isolates may also be viewed as a subset of the “concentrates” class, with very high concentrations. In some embodiments the purity of the protein feedstock comprising the modified lupin protein may be >90%, and may be described as a modified lupin protein isolate. In some embodiments, the modified lupin protein is provided as a concentrate or isolate. The protein feedstock may be in the form of a powder.

In an embodiment, the protein feedstock is in the form of a gel. The gel may have a Bloom number ranging from about 20 to about 220. The gel may have a water holding capacity ranging from about 20% to about 75%. The gel may be a cold-set gel.

Also disclosed is a composition comprising the protein feedstock as set forth above.

Also disclosed is a food product comprising the protein feedstock as set forth above. The food product may be for humans or animals including aquaculture.

### BRIEF DESCRIPTION OF FIGURES

Embodiments of the disclosure will now be described by way of example only with reference to the following non-limiting Figures.

FIG. 1 shows the relationship between acidification of 10% (w/w) lupin protein solution by various glucono-δ-lactone (GDL) concentrations % (w/v).

FIG. 2 shows the effect of ultrasound treatment time and ultrasound power on lupin gel strength.

FIG. 3 shows the effect of ultrasound treatment time and ultrasound power on lupin gel water holding capacity.

FIG. 4 shows the effect of ultrasound treatment time (0-40 minutes) at 38 W/cm² power on lupin protein concentrate solubility. a, b, c, d, e Values with different letters in the bars are significantly different (p≤0.05).

FIG. 5 shows an infrared spectrum of modified and unmodified lupin protein concentrate from (a) 1600-1660 cm⁻¹ and (b) 1200-1400 cm⁻¹.

FIG. 6 shows the effect of ultrasound treatment on gelation properties of glucono-b-lactone (GDL)-induced lupin protein concentrate during heating from 25° C. to 95° C. at a rate of 2° C./min (temperature change shown by the linear line). Circles are control samples (non-sonicated) and squares have been sonicated for 40 min at 38 W/cm².

FIG. 7 shows the effect of ultrasound treatment on gelation properties of GDL-induced lupin protein concentrate during heat preservation step at 95° C. at a rate of 2° C./min (preservation of constant temperature shown by the linear line). Circles are control samples (non-sonicated) and squares have been sonicated for 40 min at 38 W/cm².

FIG. 8 shows the effect of ultrasound treatment on gelation properties of GDL-induced lupin protein concentrate during cooling from 95° C. to 25° C. at a rate of 2° C./min (temperature change shown by the linear line). Circles are control samples (non-sonicated) and squares have been sonicated for 40 min at 38 W/cm².

### DETAILED DESCRIPTION OF EMBODIMENTS

A first embodiment provides a method of forming a protein feedstock comprising modified lupin protein. The method includes the step of providing a solution of lupin protein and passing ultrasound waves through the solution of lupin protein to form modified lupin protein. The modified lupin protein has a decreased thermal stability compared to unmodified lupin protein. The method also includes collecting the modified lupin protein.

Ultrasound treatment (i.e. sonication treatment) requires the use of acoustic waves above the threshold of human hearing (>16 kHz) and uses cavitation phenomena to alter molecules, such as a food ingredient structure, through the continued formation of a vapour cavities and bubbles in the solution. The vapour cavities and bubbles explode after few cycles releasing extreme temperatures and pressures in the cavitation zone. In addition, ultrasound treatment can cause water to split, creating reactive free radicals and H⁺ and OH ions which may help to modify the functional groups on the amino acids that make up a protein (which may be denoted “R” groups—the identity of which is known in the art). The formation of reactive free radicals and H⁺ and OH⁻ ions may also help to form new crosslinks, for example within a protein or between adjacent proteins.

When proteins dissolved in solution are subjected to ultrasound waves, the extreme energy in the resulting cavitation zone and the resulting reactive free radical(s) may promote strong changes on protein structure, which can modify protein structure, and thus functionality. Depending on the type of protein solution being subjected to treatment, a high-intensity ultrasound treatment is suitably utilised. High-intensity ultrasound typically refers to sound waves with low frequencies (20-100 kHz) and high sound intensity (10-200 W/cm²). In an embodiment, the high-intensity ultrasound waves utilised have a frequency of about 20 kHz. In an embodiment, the high-intensity ultrasound waves utilised have a power ranging from 5-50 W/cm². Ultrasound (sonication) treatment may facilitate protein unfolding and exposure of active hydrophobic protein groups (e.g. amino acid R-groups) to form modified lupin protein. Exposing hydrophobic protein groups may help to reduce the overall charge density at a surface of the modified lupin protein, which may help to decrease repulsive forces between adjacent proteins in solution. A decrease in repulsive forces may help to promote the formation of aggregates and may allow for better intermolecular crosslinking between adjacent proteins. A decrease in repulsive forces between adjacent proteins is generally accompanied by a decrease in thermal stability of the protein. Ultrasound treatment may cause a change in the secondary structure of the protein. In an embodiment, ultrasound treatment causes a change from α-helix structures to β-sheet structures. This means that the resulting modified lupin protein may have an increased proportion of β-sheets compared to unmodified lupin protein.

The solution of lupin protein may have a pH that does not allow the lupin protein to form aggregates during ultrasound treatment. In an embodiment, the pH of the solution of lupin protein is about 7.0±0.1 during ultrasound treatment. The pH of the solution of lupin protein may be adjusted immediately prior to ultrasound treatment. The pH of the solution of lupin protein may be adjusted during formation of the solution of lupin protein. The solution of lupin protein may be stored frozen and defrosted immediately prior to ultrasound treatment. The solution of lupin protein may be formed by reconstituting dried lupin protein.

The solution of lupin protein may have a concentration of lupin protein ranging from about 5% (w/w) to 20% (w/w). In an embodiment, the solution of lupin protein may have a concentration of about 10% (w/w). In practice, the lupin protein used to form the solution of lupin protein may have any purity. In an embodiment, the lupin protein is a lupin protein concentrate i.e. a solution of lupin protein having a purity (lupin protein content, w/w) that is >35%. In an embodiment, the purity of the lupin protein concentrate is >70%. In an embodiment, the lupin protein concentrate may be a lupin protein isolate having a purity>90%.

The lupin protein may be purified in a purification step prior to ultrasound treatment. For example, a crude solution of lupin protein may be formed that is then subjected to purification immediately prior to ultrasound treatment. However, in some embodiments the lupin protein is purified prior to forming the solution of lupin protein. The modified lupin protein may be purified in a purification step after ultrasound treatment. For example, crude lupin protein may be used to form the solution of lupin protein and then after ultrasound treatment the impurities are removed. In some embodiments, a lupin protein purification step is performed both before and after ultrasound treatment. Purification may include the use of differential solubilisation and precipitation, centrifugation and ultracentrifugation, ultrafiltration, size exclusion chromatography, ion exchange chromatography, HPLC and/or affinity chromatography. Following purification, the lupin protein may be lyophilized.

Collecting the modified lupin protein may include precipitation and/or lyophilization. In some embodiments, collecting the modified lupin protein includes purification of the modified lupin protein. In some embodiments collection of the modified lupin protein includes freeze-drying and/or spray drying. The modified lupin protein may be provided as a powder. In some embodiments the modified lupin protein has the properties according to Table 1.

TABLE 1
Properties of modified lupin protein

| Item | Property |
|---|---|
| Characteristic | Light yellow powder |
| Odor | Neutral to nutty |
| Flavor | Pleasant to nutty |
| Energy | 356 kcal per 100 g |
| Moisture | 5.0% Max. |
| Crude protein (dry basis N*5.5) | 68.0% Min. |
| Fat (dry basis) | 11.0% Max. |
| Dietary fibre (dry basis) | 12.0% Max. |
| Ash (dry basis) | 3.5% Max. |
| Protein digestibility | 98% |
| Protein digestibility corrected amino score | 0.53 |
| pH | 7.0 ± 0.5 |
| Gluten | Not detected |
| Phytoestrogens | Not detected |

The ultrasound waves utilised may have a frequency greater than 16 kHz. In an embodiment, the ultrasound waves have a frequency of 20 kHz. The required power of the ultrasound waves may depend on the frequency of the ultrasound waves and/or the ultrasound treatment duration. The power of the ultrasound waves may be less than about 50M/cm². In an embodiment, high-intensity ultrasound waves are utilised having a power ranging from about 5 W/cm² to about 50 W/cm². In an embodiment, the high-intensity ultrasound waves have a power ranging from about 10 W/cm² to about 40 W/cm², such as 11 W/cm² to 38 W/cm². The duration of ultrasound treatment is dependent on the intensity of the ultrasound waves. When the high-intensity ultrasound waves have a power ranging from about 5 W/cm² to about 50 W/cm², the solution of lupin protein may be subjected to high-intensity ultrasound waves for a period of 60 minutes or less. For example, the duration of ultrasound treatment may be less than about 40 minutes. In some embodiments, duration of ultrasound treatment ranges from about 20 minutes to about 40 minutes. In some embodiments duration of ultrasound treatment is about 20 minutes or less, for example between about 2 and about 20 minutes.

During ultrasound treatment the temperature of the solution of lupin protein may be maintained below an upper temperature threshold. The upper temperature threshold may be a temperature required to form aggregates of the modified lupin protein. The upper temperature threshold may be about 60° C. In some embodiments it may be beneficial to maintain the temperature of the solution of lupin protein well below the upper temperature threshold during ultrasound treatment. For example, the solution of lupin protein may be maintained below about 35° C. during ultrasound treatment. Keeping the solution of lupin protein as low as possible may help to improve the ultrasound treatment. In some embodiments the solution of lupin protein may be kept above freezing during ultrasound treatment. It should be appreciated that the temperature of the solution of lupin protein is referenced to the bulk temperature of the solution and that the effects of cavitation and the like may result in regions of the solution of lupin protein on the micro- or nano-scales having temperatures above the upper threshold temperature. Generally, but not always, ultrasound treatment causes a temperature of a solution to increase. The increase in temperature is dependent on the power of the ultrasound waves and the duration of treatment. A temperature of the solution of lupin protein may be controlled with a temperature control system. The temperature control system may include a refrigerant and/or ice.

After forming the modified lupin protein, it may be then converted into a gel. Forming a gel may include adjusting a pH of a solution comprising the modified lupin protein to an isoelectric point of the modified lupin protein. Forming a gel may include adding one or more salts to adjust an ionic strength of the solution of modified lupin protein. Forming a gel may also include heating the solution comprising the modified lupin protein to a temperature to induce aggregation of the modified lupin protein and then cooling the solution comprising the modified lupin protein to form the gel. Generally, the pH of the solution comprising the modified lupin protein is adjusted prior to heating. However, in some embodiments, the pH is adjusted during or after heating. The pH may be adjusted to near an isoelectric point of the modified lupin protein. The isoelectric pH may be about 4.5. In an embodiment the pH is adjusted to be from about 4.0 to about 5.5. The isoelectric point pH may be reached by the addition of an acid. The acid may be the hydrolysis product of glucono-b-lactone (GDL). The acid may be gluconic acid. Following acid addition, the solution of lupin protein may be mixed, for example by vortex mixing. A strength of a resulting gel may decrease as the pH is moved away from the isoelectric point.

The solution of the modified lupin protein may be heated to or above a lower temperature threshold. The lower threshold temperature may be a temperature required to start aggregation of modified lupin proteins. The beginning of aggregation may be accompanied by an increase in the elastic moduli of the solution comprising the modified lupin protein. The lower temperature threshold may be about 60° C. In an embodiment, the solution of modified lupin protein may be heated to about 75° C. or more, such as 95° C. In some embodiments the solution of modified lupin protein may be heated above about 70° C. The solution of modified lupin protein may be heated in two or more heating steps, for example at a first step at a first heating rate and then at a second step at a second heating rate. The solution of modified lupin protein may be maintained above the lower temperature threshold for a desired period of time. In an embodiment the solution of modified lupin protein is treated at a temperature ranging from about 75° C. to about 95° C. for a time ranging from about 20 minutes to about 60 minutes. The time required for aggregation of the modified lupin proteins is dependent on the temperature at which the solution of the modified lupin protein is heated to. Generally, the lower the temperature the longer the treatment time, and the higher the temperature the shorter the treatment time. In some embodiments the solution of modified lupin protein is heated to a desired temperature above the lower temperature threshold and then maintained at the desired temperature for a period of time. The solution of modified lupin protein may be cooled to below the lower temperature threshold after it has been heated to or above the lower temperature threshold to form the gel. In an embodiment the gel is a cold-set gel. The solution may be cooled to about room temperature e.g. <30° C. The solution may be maintained <30° C. for more than 60 minutes to set the gel.

A strength of the gel may be dependent on the conditions used to form the gel. Conditions that favour protein aggregation tend to form gels with a higher strength compared to conditions that are not as favourable at promoting gel aggregation. For example, heating the solution of modified lupin protein to 95° C. instead of 75° C. for the same period of time tends to increase the strength of a resulting gel. However, such a relationship does not apply in all circumstances. In some embodiments, adjusting the ultrasound conditions may influence the resulting gel properties. Likewise, adjusting a pH of the solution of modified lupin protein to be close to the isoelectric point of the protein may help to increase protein aggregation. Increasing ultrasound treatment time may also help to increase the proportion of β-sheets relative to α-helix structures, which may help to improve the ability of the modified protein to form aggregates. Aggregation promotes intermolecular crosslinking between adjacent proteins. Crosslinking can include covalent and non-covalent bonding. A strength of the gel may have a Bloom number ranging from about 20 to about 220.

When forming a gel, a concentration of the solution of modified lupin protein may range from about 5% (w/w) to about 30% (w/w). The amount of acid required to reach the isoelectric point of the modified lupin protein will vary depending on the concentration of modified lupin protein. Generally, an increase in the concentration results in an increase in the strength of a resulting gel. After the gel is formed, it may be allowed to further equilibrate in an aqueous-based solution. The gel may be washed after formation to remove any contaminates and/or any unbound protein from the gel network.

The water holding capacity of the gels is dependent on the gel strength. The water holding capacity (also referred to as water content or equilibrium water content) is a measure of how much water the network that forms the gel can adsorb. A gel with a higher strength will generally have a higher water holding capacity compared to an equivalent gel with a lower strength. The water holding capacity of a gel formed from modified lupin protein may range from about 20% to about 75%. An increase in the concentration of modified lupin protein may increase the water holding capacity.

It is important to note that without ultrasound treatment, it is not possible to form gels from native lupin protein having the properties described in the current disclosure due to the thermal stability of the lupin protein.

The required properties of the gel may be determined by the use of the gel. For example, gels used for thickening a food product may require different properties to a gel use for setting a food product. Therefore, the parameters used to control the gel properties (for example modified lupin protein concentration, ultrasound treatment time and temperature of heating during gel formation) may be adjusted to provide a gel with required strength and water holding capacity.

The gel may be maintained in its hydrated form after formation. For example, the gel may be stored at lowered temperatures to minimise degradation of the modified lupin protein, such as through hydrolysis. In an embodiment, hydrated gels are maintained at about 4° C. until use. In some embodiments, the gel is dehydrated. The dehydrated gel may be rehydrated prior to use.

The collected modified lupin protein and/or gels formed from the modified lupin protein may be used to form a food product. For example, gels may be used to form meat or dairy analogues. The modified lupin protein may provide a plant-based protein that has desirable texture and palatability. The modified lupin protein may be used as a protein feedstock. In an embodiment a composition comprises the modified lupin protein (e.g. the protein feedstock). In an embodiment a food product comprises the modified lupin protein. The modified lupin protein may be used in the preparation of plant based products such as gluten-free, vegetarian and vegan products. In an embodiment, the modified lupin protein may have the ability to provide a stable three-dimensional network to give the required texture in targeted food systems through viscosity enhancing and gelation ability.

### EXAMPLES

Embodiments will now be described with reference to non-limiting examples.

### Example 1

### 1.1 Materials

Lupin seed, Lupinus angustifolius. Coromup variety was supplied by the Department of Primary Industries and Regional Development (DPIRD) Western Australia. The seed coats were removed by using a seed dehuller (AMAR, India) and then the lupin kernels were separated from the hull by a vacuum separator (KIMSEED, Australia). Then the lupin kernels were vacuum packed and kept at 4° C. until use.

### 1.2 Methods

### 1.2.1 Preparation of Lupin Protein Concentrate

Lupin kernels were soaked in distilled water 1:3 (w/v) for 3 h at room temperature. After soaking, the ratio of the kernels:water was adjusted to 1:10 (w/v) followed by blending for 1 min at high speed by using a Waring blender (Model 32BL80, USA). Then the pH of the lupin kernel slurry was adjusted to 9 by using 1 M NaOH. The slurry was homogenised at maximum speed for 30 min using an Ingenieurburo CAT homogenizer model R50D (Hamburg, Germany). The sample was separated by centrifugation for 30 min at 2060 g at 4° C. using an Eppendorf centrifuge (model 5810 R, Hamburg, Germany). The resulting supernatant lupin protein extract was removed by decantation from the fibre pellet. The lupin kernels were soaked and extracted again using distilled water 1:5 (w/v). Then, the supernatants from the two extractions were combined. The supernatant pH was adjusted to 4.5 by using 1 M HCl to induce isoelectric protein precipitation. Next, the sample was centrifuged at 2060 g for 30 min at 4° C. to separate the protein precipitate from the supernatant. The pH of the precipitate was adjusted to 7±0.1 by using 1 M NaOH. This neutralised precipitate of lupin protein concentrate was freeze-dried using Model ALPHA 1-2 LO (Christ, Osterode am Harz, Germany) freeze-dryer then vacuum packed and stored at 4° C. until use.

### 1.2.2 Preparation of Lupin Protein Concentrate Solutions for Gelation Studies

10% (w/w) freeze dried lupin protein concentrate dispersions were prepared using deionized water and stirred for 2 h at 750 rpm using MR Hei-Standard stirrer (Schwabach, Germany) at room temperature. The resulting protein suspension was kept at 4° C. overnight to complete protein hydration after which the pH was readjusted to 7±0.1 using 0.1 M NaOH/HCl before ultrasound treatment.

### 1.2.3 High-Intensity Ultrasound (HIU) Treatment

HIU treatment was performed by using the ultrasound processor model VCX 600 (Sonics & Materials Inc, Danbury, USA) with a converter model CV26 and 13 mm titanium probe. Samples of 20 mL of lupin protein concentrate solutions (see section 1.2.2) were treated for 0, 2, 10, 15, 20 and 40 min using different ultrasound amplitudes of 10%, 20% and 40%. The HIU treatment was performed in a double wall glass beaker equipped with a chiller to maintain the sample temperature below 35° C. during ultrasound treatment.

### 1.2.3.1. Determination of High-Intensity Ultrasound Power

The applied ultrasound power was calculated according to the calorimetric technique.

Ultrasound power (P) was calculated following the formula:

P=MCp(dT/dt)

Where P (W) is ultrasound power, M is sample mass (g), Cp is the specific heat of the media (kJ/gK) and dT/dt is the rate of temperature change (T) change with time (t). Ultrasound intensity (W/cm²) is ultrasound power (P)/unit area (cm²) of the emitting surface. The calculated power intensity was 11 W/cm², 17 W/cm² and 38 W/cm² at 10%, 20% and 40% amplitude respectively.

### 1.2.4. Determination of Glucono-δ-Lactone Level to Reach Target pH

A pH around 4.5 is required in cold-set gelation to form a stable gel, since this pH reduces repulsion forces between the protein molecules and facilitates intermolecular crosslinking to form a gel network. Food additive (acidifier) glucono-b-lactone (GDL) will slowly hydrolyse to gluconic acid and reduce the pH. In order to reach the required final pH of 4.5 during gelation, the amount of GDL required first needed to be identified since its level of acidification depends on the protein type and concentration. Different amounts (0.20, 0.22, 0.25, 0.27, 0.30, 0.40, 0.50, 0.60, 0.70, 0.75, 0.80, 0.90, 1.0, 1.1, 1.2, 1.5, 1.7, 1.8 and 1.9% (w/v)) of GDL were added to 20 g aliquots of the lupin protein concentrate suspensions (section 1.2.2), followed by vertexing for 30 seconds at room temperature and stored at 4° C. for 24 h. The pH was then measured at room temperature. All measurements were done in triplicate. FIG. 1 shows pH values versus the added amount of GDL for a 10% (w/w) lupin protein solution.

### 1.2.5. Gelation of Modified Lupin Protein Concentrate Solutions

### 1.2.5.1. Acidification

The required amount of GDL powder to reach pH 4.5 was added to 20 g of 10% (w/w) modified lupin protein concentrate solutions after the various ultrasound time x power treatments (section 1.2.3.). All samples were mixed using a vortex mixer for 20 seconds before heat treatment.

### 1.2.5.2. Heat Treatment and Gel Formation

The acidified ultrasound treated lupin protein concentrate solutions were treated at 95° C. for 60 min to induce lupin protein aggregates as a pre-gelation step. After heat treatment, the solutions were cooled to room temperature in either (a) 50 ml glass containers having a width of 40 mm wide and a height of 52 mm for gel strength determination or (b) 50 ml centrifuge tubes for water holding capacity measurement. The samples were kept at 4° C. for 24 h to allow the gels to cure before gel quality analysis.

### 1.2.6 Determination Gel Strength

Gel strength was measured according to published methods (Food Hydrocolloids, 32(2), 303-311; Ultrasonics Sonochemistry, 17(6), 1075-1081). Gel strength analysis was performed at 5° C. using a TVT texture analyser (model 6700, Perten Instruments, Australia) fitted with a 5 kg load cell and a P/0.5 (12.7 mm diameter) cylinder probe attachment. Gel compression was performed at 0.5 mm/s speed with a 5 g trigger force. Gel strength was expressed in g, and all tests were performed in triplicate.

### 1.2.7 Determination of Water Holding Capacity (WHC)

After gel formation, unbound water was removed by inverting the tube containing the gel. Filter paper was used to remove any remaining free water on tube walls. Lupin gel samples were centrifuged at 1811 g for 20 min at room temperature using an Eppendorf centrifuge model 5810R (Hamburg, Germany). After centrifugation, any released water was removed by inverting the tube to drain of released water. Water remaining on tube walls were removed by filter paper. WHC % calculated as the difference in water content between centrifuged sample to original gel samples.

### 1.2.8 Protein Solubility

2 mg/mL lupin protein concentrate (section 1.2.2) was solubilised in sulphate buffer pH 7. These lupin protein suspensions were stirred for 2 h and then kept at 4° C. overnight to complete hydration. Protein concentration was conducted using a bicinchoninic acid protein assay kit (Sigma-Aldrich Co. Australia). Lupin protein suspensions were centrifuged at 20000 g for 15 min at room temperature using Heraeus centrifuge (model Pico17, Germany). Protein solubility (%) was calculated as (supernatant protein concentration after centrifugation/total protein concentration before centrifugation)*100.

### 1.2.9 Zeta Potential

Freeze dried lupin protein concentrate from native (untreated) and ultrasound treated samples 2 mg/mL were solubilized in milli-Q water at room temperature. Lupin protein dispersions where mixed and kept for 2 h before the analysis. Zeta potential was analysed using a Zetasizer Nano ZS (Malvern Instrument Ltd., Malvern, Worcestershire, UK).

### 1.2.10 Particle Size Distribution

The particle size was determined immediately after lupin protein concentrate was dispersed in milli-Q water for 2 h at 2 mg/mL concentration. The particle distribution was monitored during three successive readings using a Mastersizer laser light scattering analyzer (Mastersizer 2000, Malvern Instruments Ltd., UK). The particle size was expressed as surface weighted mean (D3,2) and volume-weighted mean (D4,3).

### 1.2.11 Lupin Gel Rheological Measurements at Small Deformation

High-intensity ultrasound treated lupin protein and non-treated lupin protein dispersions where prepared as described through section 1.2.2-1.2.5. To achieve required pH, 1% of GDL was mixed with samples 2 min prior to test. Storage modules (G′) were measured using controlled stress rheometer TA Instruments AR-G2 (TA Instruments, Leatherhead, UK) fitted with parallel plates (40 mm diameter and 1 mm gap). Measurements were performed at a constant strain of 0.05%, which was within the linear region, and at 1 Hz frequency. The samples were heated from 25° C. to 95° C. at a heating rate of 2° C./min, kept at 95° C. for 20 min, and cooled down to 25° C. at a cooling rate of 2° C./min. All measurements were conducted in triplicates.

### 1.2.12 Lupin Protein Structure Profile

Lupin protein profile was investigated using SDS-PAGE using reducing and non-reducing electrophoresis as described by (Villarino, Jayasena, Coorey, Chakrabarti-Bell, Foley, Fanning & Johnson, 2015; doi:10.1016/j.foodres.2014.11.046). Reducing and non-reducing SDS-PAGE was conducted to investigate the effect of ultrasound treatment on the lupin protein concentrate. 10 μg of lupin protein concentrate was dissolved in 10 μL of NuPAGE sample buffer (Invitrogen). The samples were injected in NuPAGE Novex 4-12% Bis-Tris gels (Invitrogen, Sigma Aldrich. Australia). MES SDS running buffer (Invitrogen) was added before electrophoresis carried out for 1 h at 200V. Electrophoresis was stopped when samples bands reach 1 cm from gel bottom. 50 ml Bio-Safe Coomassie G-250 stain (Bio-Rad Laboratories, USA) was used for protein staining. Gel distaining was performed by soaking the gel in deionized water five times. Molecular weight markers (Unstained Mark 12 protein standard, Invitrogen, Sigma Aldrich. Australia) were used as a reference to determine lupin protein fraction molecular weight by comparing the travelling distance of each fraction with an equivalent distance of the molecular weight marker band.

### 1.2.13 Differential Scanning Calorimetry

Differential scanning calorimetry (DSC) measurements were performed using TA Instruments DSC 2910 (New Castle, USA). About 5 mg of sample was weighed into a hermetically sealed aluminium pan. Lupin protein concentrate thermogram was recorded under 5° C./min heating rate from 25° C. to 160° C. under a nitrogen atmosphere. The DSC analyser was calibrated with indium. An empty pan was used as a reference. Measurements were analysed to determine the onset temperature (Tₒₙₛₑₜ), peak temperature (Tₚₑₐₖ) and enthalpy of denaturation (ΔH) using Universal Analysis 2000 software, version 4.5A (TA Instruments).

### 1.2.14 Fourier-Transform Infrared Spectra (FTIR)

FTIR was used to investigate the lupin protein structural changes generated by ultrasound treatment power at 11 W/cm², 17 W/cm² and 38 W/cm² for 0, 2, 10, 15, 20 and 40 min. Freeze-dried lupin protein concentrates were analysed by Thermo Scientific Nicolet iS50 FTIR spectrometer coupled to a smart Smart iTR Attenuated Total Reflectance (ATR) sampling accessory (Thermo Scientific, Madison, Wis., USA). FTIR Spectra were recorded in the range 4000-400 cm⁻¹ at a spectral resolution of 4 cm⁻¹ with the co-addition of 64 scans. A background spectrum was recorded from the clean diamond ATR crystal before each sample with the co-addition of 64 scans. Post-processing was performed using OPUS v7.0 (V7.0, Bruker, Ettlingen, Germany), and the FTIR spectra background corrected and vector normalised across wavelengths covering Amide I, Amide II, and Amide III spectra regions.

### 1.3 Statistical Analysis

Analyses were performed in triplicate unless stated otherwise. The data were statistically analysed with SPSS vs.21 software. Two-way analysis of variance (ANOVA) with a 95% confidence interval was used to assess the significance of the results obtained. The ANOVA data with P<0.5 were considered as statistically significant.

### 1.4 Results and Discussion

### 1.4.1 Lupin Gel Strength

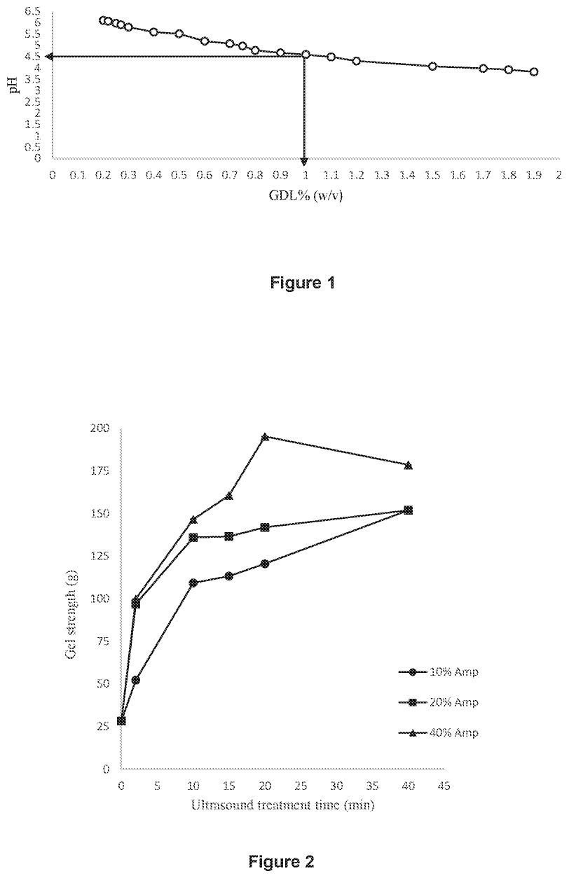

Gel strength is one of the most important gel quality attributes. The effect of ultrasound treatment time and ultrasound power on lupin gel strength is provided in FIG. 2. Ultrasound treatment time, ultrasound power and their interaction had a significant effect (p≤0.05) on lupin protein gel strength. It has been found that lupin gel strength varied from 28.33 g-195.33 g depending on the ultrasound treatment conditions. Native lupin protein gel with no ultrasound treatment had significantly lowest gel strength (p≤0.05), while 38 W/cm² (40% Amp) treatment had significantly highest (p≤0.05) lupin protein gel strength compare to 11 W/cm² (20% Amp) and 17 W/cm² (10% Amp) respectively at all time treatments. On the other hand, 20 min treatment time at all ultrasound power, assigned the significantly highest gel strength compared with all treatment times. Accordingly, 38 W/cm² for 20 min treatment time was the highest recorded gel strength. Previous studies showed that moderate ultrasound treatment time can improve gel strength by facilitating protein unfolding and exposing active hydrophobic protein groups for better intermolecular crosslinking ability in soybean and whey proteins gels, although no studies had been reported on lupin protein (Hu, Cheung, Pan, & Li-Chan, 2015; Shen, Fang, Gao, & Guo, 2017; Shen, Zhao, Guo, Zhao, & Guo, 2017). In addition, it has been reported that increased time of ultrasound treatment to 40 min did not improve whey protein gel significantly compare to mild treatment of time 20 min at 107 W/cm². However, in this study, lupin protein gels show higher gel strength than ultrasound treated soybean protein gels reported in the literature (Hu, Li-Chan, Wan, Tian, & Pan, 2013). It is important to note that although the gels formed from modified lupin protein has been compared to soy protein gels, the differences in protein structure between lupin and e.g. soy protein means that the methods used to form soy protein gels cannot always be used to form modified lupin-protein gels. For example, stable gels formed from soy protein can be formed without ultrasound treatment, whereas stable gels formed from lupin protein gels cannot.

### 1.4.2 Lupin Gel Water Holding Capacity

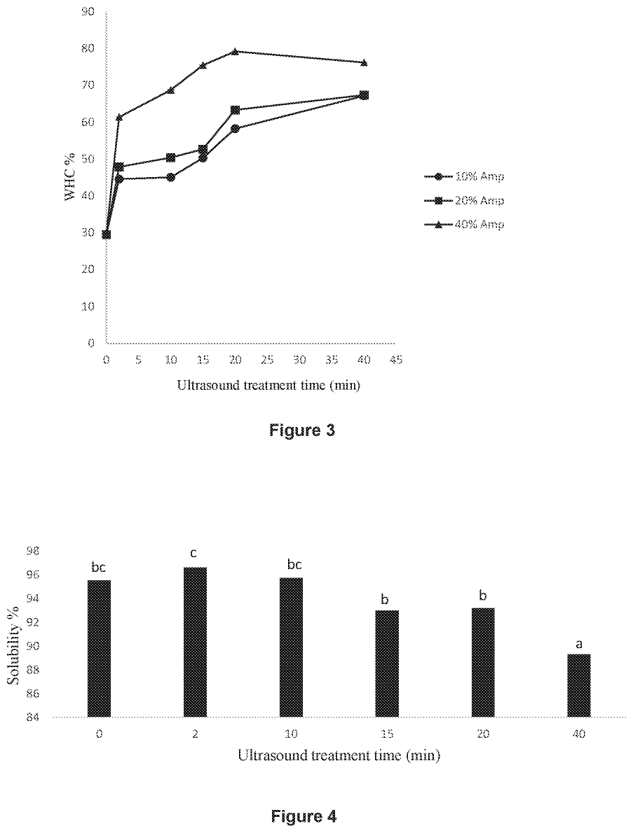

Water holding capacity (WHC) of lupin protein gels ranged from around 29%-79% between native and ultrasound treated lupin protein gels (FIG. 3). There was a significant (p≤0.05) influence of the ultrasound treatment time and power. The significantly lowest (p≤0.05) WHC recorded in this study was for untreated lupin protein gels. In this study, the highest applied ultrasound treatment time and power values (38 W/cm²/20 min) gave the highest recorded lupin protein gel WHC (79%). Ultrasound power 38 W/cm² has the most significant positive effect on lupin protein gels WHC compare to the other two powers (11 W/cm² and 17 W/cm²) used in this study. On the other hand, increasing ultrasound treatment time also had a positive significant (p≤0.05) on lupin protein gel WHC. It can be seen that WHC of lupin gels improved significantly (p≤0.05) due to ultrasound treatment. This may be due to modifying protein particle size and cross-linking ability by ultrasound treatment. This cross-linking can create a more uniform and dense gel structure, which can retain more water between protein molecules in the gel matrix (Hu et al., 2013; Morales, Martinez, Pizones Ruiz-Henestrosa, & Pilosof, 2015; Nazari, Mohammadifar, Shojaee-Aliabadi, Feizollahi, & Mirmoghtadaie, 2018; Shen, Fang, et al., 2017). However, WHC of lupin protein gel was less than those from soybean and whey proteins, which may be due to their sample purity compared to the current sample (in terms of % w/w) or due to the pH around 4.5 used on this study. In addition, moderate WHC may be required for emulsion gel systems, which is essential in some food matrices requiring oil binding ability. Ultrasound treated lupin protein concentrate and isolate may have potential for use as successful alternatives to animal proteins in these types of products.

### 1.4.3 Lupin Protein Solubility

Protein solubility is determined as the protein content in the supernatant after centrifugation at 20000 g. The effect of ultrasound treatment at 38 W/cm² for 0, 2, 10, 15, 20 and 40 min is shown in FIG. 4. There was no significant difference (p≤0.05) in lupin protein solubility after ultrasound treatment for 2 min and 10 min compared to native (non-treated) lupin protein. Increasing ultrasound treatment exposure time led to significantly (p≤0.05) reduced lupin protein solubility especially for 40 min treatment. These results have been confirmed by particle size analysis, which showed that ultrasound treatment increases lupin protein D₄₃ significantly (p≤0.05) (Table 2) after 40 min. Studies have shown that increased ultrasound treatment times can reduce protein solubility of soy and millet protein due to formulation of insoluble protein aggregates, where the formulation of small protein aggregates can increase protein particle size leading to easier protein precipitation and reduce protein solubility.

### 1.4.4 Lupin Protein Particle Size

Table 2 shows the particle size (μm) distribution for native lupin and ultrasound treated (38 W/cm²) lupin protein concentrates at 20° C. Ultrasound treatment leads to a significant (p≤0.05) increase in the particle size (volume-mean diameter (D₄₃)). Lupin protein concentrate treated at 38 W/cm² ultrasound for 40 min increased lupin protein particle size D₄₃ to 69.21 μm compare to 28.24 μm in native lupin protein concentrate. Cavitation phenomena induced from ultrasound treatment has a major effect on protein unfolding followed by hydrophobic aggregation, creating relatively large agglomerated protein particles (Arzeni et al., 2012; Hu et al., 2013; Jambrak, Lelas, Mason, Kre§ id, & Badanjak, 2009). On the other hand, ultrasound treatment for 2 min reduced the volume mean diameter D₄₃ significantly (p≤0.05). Native lupin protein has a smaller particle size than native of soybean protein (Berghout, Boom, & van der Goot, 2015; Morales et al., 2015). Despite that lupin protein particle size increasing significantly (p≤0.05) after ultrasound treatment for 40 min, it still relatively smaller than soybean protein particle size.

TABLE 2
Particle size and of ultrasound treated lupin protein dispersions.

| Ultrasound | | | | | |
|---|---|---|---|---|---|
| treatment time (min) | d(0.1)μm | d(0.5)μm | d(0.9)μm | D (3.2) (μm) | D (4.3) (μm) |
| 0 | 4.81 ± 0.81a | 16.12 ± 0.13a | 78.43 ± 34.53a | 10.0 ± 2.58a | 28.24 ± 0.63a |
| 2 | 1.52 ± 0.66ab | 13.78 ± 1.7a | 44.68 ± 0.55a | 4.85 ± 0.58a | 20.44 ± 1.9a |
| 10 | 10.57 ± 1.71bc | 25.74 ± 4.94ab | 62.39 ± 15.66a | 33.82 ± 7.77ab | 19.94 ± 3.61ab |
| 15 | 14.87 ± 3.75c | 43.34 ± 13.24bc | 119.56 ± 37.77b | 30.63 ± 8.36bc | 57.42 ± 17.54bc |
| 20 | 13.69 ± 3.44c | 34.42 ± 10.3ab | 79.72 ± 29.32a | 26.06 ± 7.21bc | 41.73 ± 14.04abc |
| 40 | 17.94 ± 4.32c | 59.35 ± 12.8c | 134.3 ± 31.34b | 38.03 ± 9.08bc | 69.21 ± 15.8c |

a, b, c, d, e Values with different letters in the same column are significantly different (p ≤ 0.05).

### 1.4.5 Zeta Potential

The presence of more negative amino acids on the surface of protein molecules results in negative Z potential of the protein and vice versa. The results (Table 3) indicated that the Z potential of native lupin protein concentrate decreased upon ultrasound treatment at 38 W/cm² for 40 min from −26.85 to −15.48 mV. This reduction on lupin protein particle negative charge leads to a reduction of repulsion forces between protein particles, which promotes aggregation. This phenomenon was caused by structural change upon ultrasound treatment that was confirmed by particle size results (Table 2) and FTIR spectra results.

TABLE 3
Thermal properties and zeta potential of native and ultrasound
treated lupin protein concentrate at 38 W/cm² for 40 min.

| | Tₒₙₛₑₜ | Tₚₑₐₖ | ΔH | zeta |
|---|---|---|---|---|
| Samples | (° C.) | (° C.) | (j/g) | (mV) |
| Native | 70.40 ± 0.24a | 104.99 ± 0.04a | 288.28 ± 0.88a | −26.85 ± 0.07a |
| Treated | 65.46 ± 0.31b | 102.97 ± 0.86a | 260.70 ± 0.71b | −15.48 ± 0.25b |

a, b, c, d, e Values with different letters in the same column are significantly different (p ≤ 0.05).

### 1.4.6 Differential Scanning Calorimetry

The thermal properties of lupin protein concentrates including onset temperature (Tₒₙₛₑₜ), peak temperature (Tₚₑₐₖ) and enthalpy of denaturation (ΔH) for native (non-treated lupin protein) and ultrasound treated lupin protein is shown in Table 3. Both native lupin protein and ultrasound treated concentrates show one single broad endothermic denaturation peak (Tₚₑₐₖ) at 104.99° C. and 102.97° C. respectively. Tₒₙₛₑₜ and ΔH for the ultrasound treated samples (38 W/cm² for 40 min) were reduced significantly (p≤0.05) compared to non-treated samples. Protein thermal stability has been related to protein structure complexity of secondary and tertiary structure, and any alteration of the protein thermal properties might be due to changes in protein conformational structure which facilitates denaturation. This result may highlight that ultrasound treatment reduces lupin protein thermal stability due to some protein structural changes, such as increasing a proportion of β-sheets. This alteration on lupin protein structure due to ultrasound treatment was confirmed by particle size, and zeta and FTIR.

### 1.4.7 Fourier-Transform Infrared Spectra (FTIR)

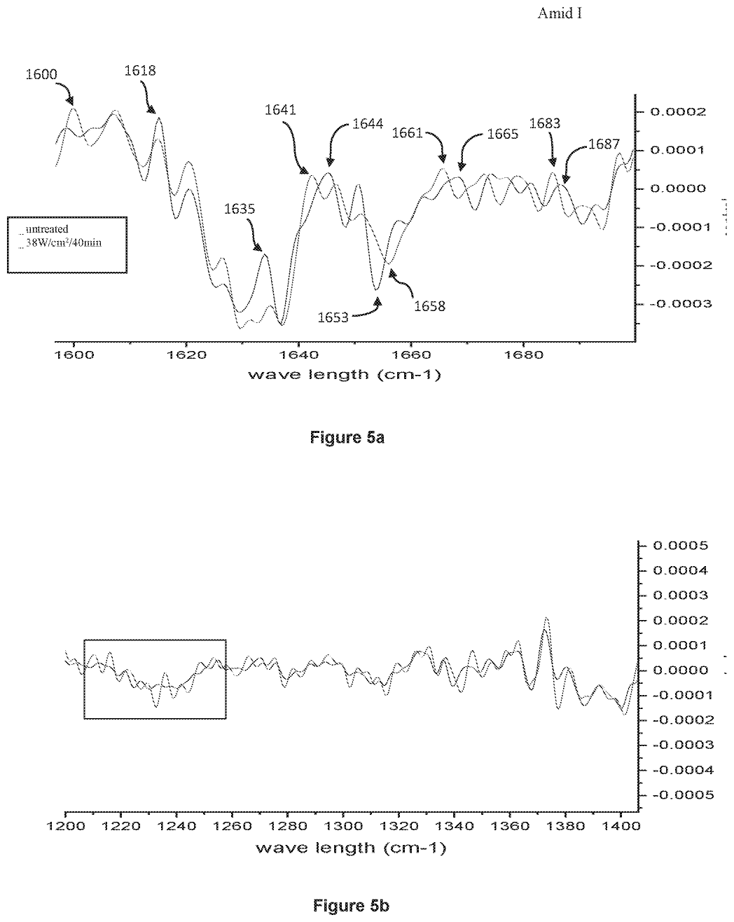

To investigate the effect of ultrasound treatment time and power on lupin protein structure, the amide bands I, and III were analyzed by monitoring a shift in peak positions (see FIG. 5). Absorption on the amide I spectra (FIG. 5a) relates to C═O stretching vibration on the wave number range between 1600-1700 cm⁻¹ FTIR spectra for lupin protein secondary structure. The α-helix and β-sheet structures on the amid I spectra are present at the wave number 1662-1655 cm⁻¹ and 1272-1264 cm⁻¹ respectively. Amid II and Ill absorption signals are assigned to the stretching vibration of C—N and N—H of protein peptide side chain over the range 1480-1575 cm⁻¹ and 1200 to 1400 respectively. Comparing FTIR spectra of native lupin protein to ultrasound treated sample at 38 W/cm²/40 min on the amide I band, shows slight shifting of the peaks on the wave number 1661 to 1665 cm⁻¹. This can be related to alteration of α-helix to β-sheet structure due to protein denaturation and aggregation which confirms the particle size and zeta potential findings. In addition, in the amide I region ultrasound treated lupin protein shows an increase in the signal absorbance at 1618 cm⁻¹ (FIG. 5a) which is more evidence of forming protein aggregated β-sheet structure. FIG. 5a for ultrasound treated lupin protein concentrate has a larger amide I peak at 1635 cm⁻¹ compared to untreated lupin protein concentrate, which is assigned to the formation of antiparallel β-sheet. This may confirm that ultrasound treatment facilitates protein unfolding and distrupts the conformation of the lupin protein. FTIR spectra on the amide II region at 1530, 1538, 1555 and 1570 cm⁻¹ show missing peaks after ultrasound treatment. On the other hand, lupin protein FTIR spectra on the amide III reign between 1250-1230 cm⁻¹ (FIG. 5b) shows the formation of new peaks after ultrasound treatment, which may be assigned to the formation of new aggregates, creating larger particles.

### 1.4.8 Sodium Dodecyl Sulfate-Polyacrylamide Gel Electrophoresis (SDS-PAGE)

SDS-PAGE of lupin protein shows the typical profile of main lupin protein subunits a conglutin (11S globulins) and β conglutin (7S globulins). Comparing the electrophoresis patterns of native lupin protein to ultrasound treated lupin protein shows no major changes on lupin protein SDS-PAGE pattern, which suggested that ultrasound did not modify lupin protein primary structure or intermolecular di-sulphide crosslinking and suggests that noncovalent bonds such as electrostatic and hydrophobic interaction dominated the newly formed lupin protein aggregates.

### 1.4.9 Rheological Properties

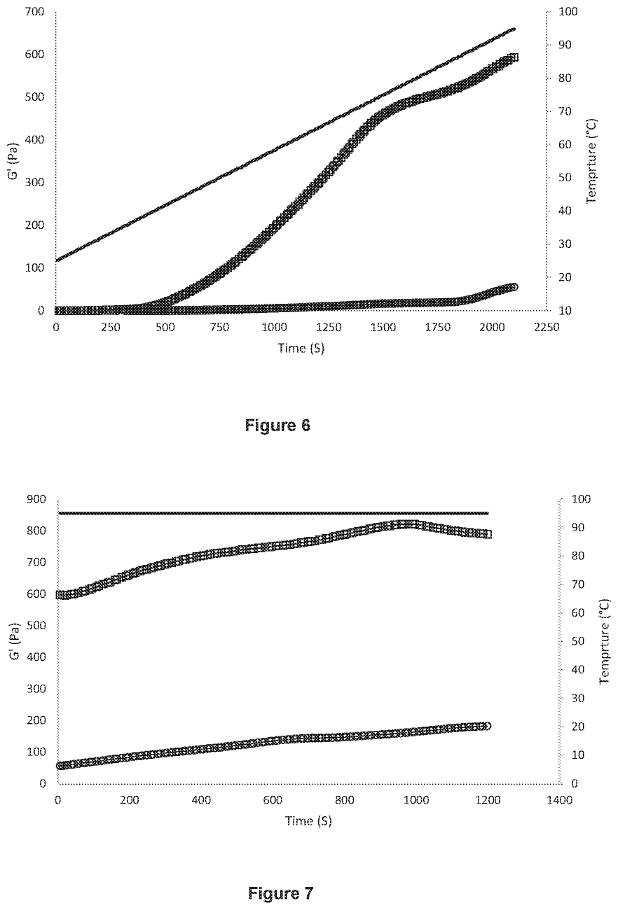

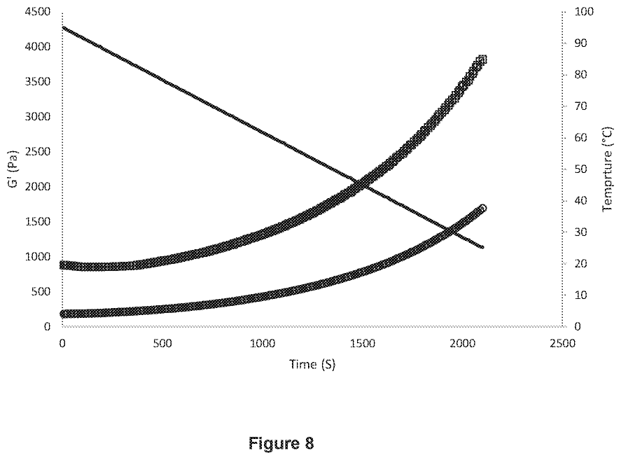

Controlled stress rheometer was used to monitor lupin protein structural development during the formation of lupin protein concentrate gels. From FIG. 6, it was observed that ultrasound treated samples have higher elastic moduli (G′) than untreated lupin samples, which indicate the ability of lupin protein to form gel network after ultrasound treatment. The ultrasonicated sample started developing texture after 500 seconds (40° C.), while untreated sample started to develop texture after 1750 seconds (70° C.). This can be noticed by increasing the value of G′ due to the protein aggregate formation, confirming that ultrasound treatment modifies the protein structure by unfolding some polypeptides, which facilitates intermolecular interactions due to lowering the pH because of GDL hydrolysis resulting in reduce repulsive electrostatic forces between adjacent proteins in the lupin protein concentrate. Holding lupin protein dispersions at 95° C. for 20 min (FIG. 7) leads to a slight but steady increase of G′ for untreated samples. On the other hand, ultrasonicated samples show some reduction on G′ from 800 Pa to 700 Pa after 1000 sec, which is due to hydrogen bonding disturbance and the formation of hydrophobic interaction. However, compared to untreated samples, ultrasonicated treated samples have a higher G′ for the same amount of heating. This confirms that ultrasound treatment reduces lupin protein thermal stability. Upon cooling (FIG. 8) ultrasound treated sample show a higher G′ value than untreated sample. Ultrasound treated samples reached a maximum value of 4200 Pa at 25° C., while untreated sample reached a maximum value of 1600 Pa at 25° C. The properties of gels formed from ultrasonicated lupin protein concentrate exhibits a stronger gel network likely formed through newly expose active groups on the polypeptides side chain as a result of the decreased thermal stability of lupin protein (e.g. an increase in the proportion of β-sheets). It can be noticed that changes in lupin protein particle size, zeta potential and DSC after ultrasound treatment has a significant effect on its viscoelastic properties. Increasing particle size with low repulsion forces leads to lupin protein that can develop a gel network faster than untreated lupin samples. In addition, reduced lupin protein thermal stability promotes protein unfolding and aggregation process faster than native lupin protein.

### 1.5 Conclusion

Ultrasound treatment changed significantly lupin protein gel strength, WHC, viscoelastic gel properties (G′) protein solubility, particle size and zeta potential. Ultrasound creates slight modification on lupin protein secondary structure as confirmed by FTIR spectroscopy. In addition, ultrasound treatment creates reductions on lupin protein thermal properties. SDS-PAGE electrophoresis results show no changes to major lupin protein subunits molecular weight. For the first time for lupin, high-intensity ultrasound treatment shows great potential to improve lupin protein gel quality attributes (gel strength, WHC, solubility, and viscoelastic properties (elastic modules G′). Improving Australian sweet lupin techno-functional properties may allow the use of lupin protein as a vegetable protein source in the food industry as a food ingredient, which may meet consumers demanding healthier food alternatives and food processing requirements.

### Example 2

### 2.1 Materials

Lupin seed was prepared according to section 1.1. in Example 1.

### 2.2 Methods

### 2.2.1 Preparation of Lupin Protein Concentrate

Lupin protein concentrate was prepared according to section 1.2.1 in Example 1.

### 2.2.2 Identifying Factors Controlling Lupin Protein Gel Ability Using Ultrasound Treatment Under Cold-Set Gel Conditions

Five independent factors with a two-level fractional factorial experimental design 2⁵⁻¹ was chosen to determine their effect on gel quality to determine the effect of independent variables: Ultrasound treatment time (USt) (min), Ultrasound treatment intensity (USI) (W/cm²), Thermal treatment temperature (TT) (° C.), Thermal treatment time (Tt) (min) and pH on lupin protein concentrate gel strength (g), water holding capacity % and gel yield (%) using Design Expert software version 11. Design Expert software was used to generate experimental runs (Table 4) using minimum and maximum values of independent variables.

TABLE 4
Factorial independent variables with actual and coded values

| | Independent | | Actual values | | Coded values | |
|---|---|---|---|---|---|---|
| Factors | variables | Units | Min | Max | Min | Max |
| A | Ultrasound | min | 2 | 20 | −1 | +1 |
| | treatment | | | | | |
| | time (USt) | | | | | |
| B | Ultrasound | W/cm² | 11 | 38 | −1 | +1 |
| | treatment | | | | | |
| | power (USp) | | | | | |
| C | Thermal | ° C. | 75 | 95 | −1 | +1 |
| | treatment | | | | | |
| | temperature (TT) | | | | | |
| D | Thermal | min | 20 | 60 | −1 | +1 |
| | treatment | | | | | |
| | time (Tt) | | | | | |
| E | pH | pH | 4.5 | 5.5 | −1 | +1 |

### 2.2.3 Preparation of Lupin Protein Gels

10% (w/w) lupin protein solutions were prepared according to section 1.2.2. in Example 1. 10% (w/w) lupin protein concentrate dispersion were prepared using deionized water and stirred for 1 h at room temperature. Then, protein solutions where kept at 4° C. overnight to complete protein hydration. pH was adjusted to 7+/−0.1 using 0.1M NaOH or HCl before high-intensity ultrasound treatment.

### 2.2.4 High-Intensity Ultrasound Treatment

High intensity ultrasound treatment was carried out using ultrasound processor model VCX 600 (Sonics & Materials Inc, USA) with converter model CV26 and a 13 mm titanium probe to sonicate 20 ml of 10% (w/w) lupin protein concentrate solutions for 2 minutes or 20 minutes depending on run limits. Lupin protein concentrate solution were sonicated in a double wall glass beaker equipped with chiller to maintain sample temperature below 35° C. during ultrasound treatment. After ultrasound treatment the samples were transfer to 60 ml glass containers having a diameter of 40 mm. The power and intensity of the ultrasound treatment is 11 W/cm², 17 W/cm² and 38 W/cm² at 10%, 20% and 40% amplitude, respectively, as described in section 1.2.3.1 in Example

### 2.2.5 Investigating Addition of Glucono-δ-Lactone (GDL)

0.5% or 1% (w/v) of GDL were added to lupin protein concentrate dispersions to give final pH of around 5.5 and 4.5 respectively.

### 2.2.6 Acid Induced Gelation

The required amount of GDL powder was added 2 minutes prior to heat treatment (section 2.2.7). GDL will slowly hydrolyses to gluconic acid and reduce the pH to required point depending on run limits. All samples were mixed before heat treatment using a vortex mixer.

### 2.2.7 Heat Treatment

Sonicated (modified) lupin protein concentrate solutions were treated at 75° C. or 95° C. for 20 minutes or 60 minutes (Table 4). Following heating, the modified lupin protein concentrate solutions were cooled to room temperature to form a gel, then kept at 4° C. for 24 h to let the gel equilibrate before analysis.

### 2.2.8 Determination of Lupin Gel Strength

Gel strength was measured according to section 1.2.6 in Example 1.

### 2.2.9 Determination of Water Holding Capacity (WHC)

WHC test were preformed according to section 1.2.7 in Example 1.

### 2.2.10 Determination of Gel Yield

After the lupin gel was formed, the unbound free water was carefully removed by contacting filter paper with the unbound free water being careful to not remove water from the gel. The gel yield is the difference between fresh gel sample (after removing free water) to original sample weight. The gel samples were accurately weighed after removing the free water. Gel yield was calculated following the equation below:

Gel yield=(Wg/Wt)*100

Where Wg is the gel sample weight in grams after removing unbound water and Wt is weight in grams of original modified lupin protein solutions including the weight of added GDL.

### 2.3 Statistical Analysis

All results expressed as mean±standard deviation. Design expert software (V11) (Minneapolis, USA) used to create the model and analyse the results (Montgomery, 2017). One-way ANOVA and Tukey test was used to compare results on each dependent variable result. Pearson's correlations between dependent factors were analysed using SPSS statistics (V23, SPSS Inc., Chicago, Ill., US).

### 2.4 Results and Discussion

### 2.4.1 the Influence of Independent Variables on Lupin Protein Gel Strength

Gel strength is one of the most important gel properties for use as an edible feedstock. Lupin protein concentrate gel strength ranged from 11 g-215 g (Table 5) depending on the conditions used to form the gel. The model shows that, gel strength is significantly (p≤0.05) influenced by TT, USt and USp (Table 3). In addition, Tt demonstrates positive effects on lupin gel strength but not significant (p≤0.05). It is reported that s 20 min USt can improve gel strength due to protein denaturation and exposure of active protein groups which improve the ability of form intermolecular crosslinks in soybean and whey protein gels, which is consistent with the current results. In contrast, prolong USt ≥(40 min) has negative impact on soybean protein gel strength. However, lupin protein gels show higher gel strength than gels formed from soybean protein after sonication treatment (˜50.9 g). Factorial analysis shows that pH has a negative effect on lupin gel strength. It has been reported that lowering pH value to point near isoelectric point will increase gel strength due to a reduction in the repulsion forces and the increase in protein aggregation. However, the effect of pH was not significant (p≤0.05) for the current example. There have been no studies focusing on lupin gelation properties under cold-set gel and/or ultrasound treatment so that soybean protein and whey protein used as a comparative reference.

### 2.5 the Influence of Independent Variables on Lupin Protein Gel Water Holding Capacity (WHC) and Gel Yield

Ultrasound treatment improved lupin gel WHC significantly (p≤0.05), see Table 5. The ANOVA factorial analysis shows that WHC of lupin gel is influenced by USt, USp and TT (Table 5). These results were in line with those from soybean, pea and whey protein after ultrasound treatment. It has been reported that ultrasound treatment for 20 min improved WHC of lupin protein significantly but increasing the ultrasound treatment to 40 min didn't improve WHC of whey protein. In contrast, increasing USt for more than 20 min decreased lupin protein gel WHC. Modifying protein structure, protein partial size, facilitation of protein unfolding, and exposure of hydrophobic groups, can build highly crosslinked gel network thus improving WHC. In addition, reducing repulsion forces by lowering pH helps to create dense protein networks via formation of hydrophobic interactions, which can entrap water (Kohyama, Sano, & Doi, 1995; Puppo, Lupano, & Anon, 1995). Pearson's correlation demonstrated a significant positive association (R=0.799**, P=0.01) between gel strength and water holding capacity. Firm and strong gel networks can entrap more water due to a more stable structure even during vigorous centrifugation compare to weak gel network.

TABLE 5
Independent and dependent factors with their actual values on factorial experimental design.

| | Actual values of variables | | | | | Response factors | | |
|---|---|---|---|---|---|---|---|---|
| | A | B | C | D | E | Gel strength | WHC | Gel yield |
| Run | min | W/cm² | ° C. | time | pH | g | % | % |
| 1 | 20 | 38 | 95 | 20 | 4.5 | 215.00 ± 5.66k | 71.71 ± 0.12j | 97.29 ± 0.12b |
| 2 | 20 | 38 | 95 | 60 | 5.5 | 210.67 ± 4.24k | 61.63 ± 0.69i | 96.96 ± 0.06b |
| 3 | 2 | 11 | 95 | 20 | 4.5 | 29.00 ± 1.41bc | 50.93 ± 0.18efg | 96.66 ± 0.18b |
| 4 | 2 | 11 | 95 | 60 | 5.5 | 50.33 ± 4.24e | 50.35 ± 0.77efg | 96.08 ± 0.69b |
| 5 | 20 | 10 | 75 | 20 | 4.5 | 39.67 ± 2.83d | 43.69 ± 0.14cde | 95.66 ± 0.33b |
| 6 | 20 | 38 | 75 | 20 | 5.5 | 37.33 ± 2.12cd | 43.7 ± 0.8cde | 96.79 ± 0.54b |
| 7 | 2 | 38 | 75 | 60 | 5.5 | 25.67 ± 1.41b | 42.39 ± 1.13cd | 93.34 ± 0.7b |
| 8 | 2 | 38 | 95 | 20 | 5.5 | 82.67 ± 2.12h | 52.65 ± 1.14fgh | 97.45 ± 0.5b |
| 9 | 20 | 11 | 95 | 20 | 5.5 | 170.67 ± 0.71j | 58.39 ± 1.52hi | 97.16 ± 0.8b |
| 10 | 20 | 11 | 95 | 60 | 4.5 | 119.67 ± 2.12i | 50.08 ± 1.04efg | 94.17 ± 0.96b |
| 11 | 2 | 11 | 75 | 60 | 4.5 | 24.00 ± 0.71b | 37.24 ± 0.86bc | 96.91 ± 0.86b |
| 12 | 2 | 38 | 95 | 60 | 4.5 | 66.00 ± 1.41g | 55.72 ± 0.97ghi | 85.21 ± 0.41a |
| 13 | 2 | 11 | 75 | 20 | 5.5 | 11.00 ± 1.41a | 22.21 ± 0.38a | 84.04 ± 0.32a |
| 14 | 20 | 38 | 75 | 60 | 4.5 | 60.67 ± 1.41fg | 53.44 ± 1.1fgh | 97.36 ± 0.47b |
| 15 | 2 | 38 | 75 | 20 | 4.5 | 24.00 ± 1.41b | 30.04 ± 1.12b | 97.69 ± 0.25b |
| 16 | 20 | 11 | 75 | 60 | 5.5 | 56.00 ± 2.12ef | 47.48 ± 1.34def | 97.33 ± 0.7b |

Means values with different letters in the same column indicate significant differences (P < 0.05).

Gel yield of modified lupin protein concentrate has been improved significantly (p≤0.05) after ultrasound treatment. The maximum gel yield belongs to Run 1 (Table 5) at 97.17% which is significantly higher than 84.6% from Run 13 (Table 5). The factorial analysis shows that USt is the most significant factor affecting lupin protein concentrate gel synthesis (Table 5). This result can be due to changes on protein partial size and protein conformational structure (Arzeni et al., 2012; Hu et al., 2015; Jambrak et al., 2009). In addition, factorial analysis model shows that increasing pH value affects gel yield negatively, as when the pH is far from the isoelectric point high repulsion forces leads to a loss in gel network and ultimately water loss. However, ANOVA analysis shows that the effect of pH was not significant for the current example. Pearson's correlation analysis showed positive but not significant interactions (R=0.264, P=0.05) and (R=0.341, P=0.05) between [gel yield]:[gel strength], and [gel yield]:[WHC], respectively. Water synereses from lupin gel protein networks depends mainly on the ability of the protein to bind water molecules through hydrophilic interactions such as hydrogen bonds. However, lupin protein gel network shows comparable gel yield to those from soy and whey protein.

TABLE 5
ANOVA analysis for the fractional factorial model
for incremental changes of each response. Blank
entries indicate non-significant results.

| Response | Model | | USt | USp | TT | Tt | pH |
|---|---|---|---|---|---|---|---|
| Gel strength | F | 46.32 | 80.97 | 10.70 | 100.76 | | |
| | P | <0.0001 | <0.0001 | 0.0084 | <0.0001 | | |
| WHC | F | 16.21 | 13.79 | 4.56 | 30.27 | | |
| | P | 0.0002 | 0.0030 | 0.0541 | 0.0001 | | |
| Gel yield | F | 24.53 | 26.85 | | | | |
| | P | <0.0001 | 0.0008 | | | | |

### 2.3 Conclusion

Factorial analysis was used to explore the effect of ultrasound treatment time (USt) (min), ultrasound treatment power (USp) (W/cm²), thermal treatment temperature (TT) (° C.), thermal treatment time (Tt) (min) and pH on lupin protein gel strength, water holding capacity and gel yield. The model shows that lupin protein gel properties are influenced significantly by the effect of independent variables USt, USp and TT.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments.

It will be understood to persons skilled in the art of the invention that many modifications may be made without departing from the spirit and scope of the invention.

1. A method of forming a protein feedstock comprising modified lupin protein that has a decreased thermal stability compared to unmodified lupin protein, the method comprising:
providing a solution of lupin protein;
passing ultrasound waves through the solution of lupin protein in a manner to form the modified lupin protein; and
collecting the modified lupin protein.

2. A method as claimed in claim 1, wherein the modified lupin protein has an increased proportion of β-sheets compared to unmodified lupin protein.

3. A method as claimed in claim 1 or 2, wherein the ultrasound waves are high-intensity ultrasound waves.

4. A method as claimed in any one of claims 1 to 3, wherein the ultrasound waves have a frequency of 20 kHz and a power ranging from about 5 W/cm² to about 50 W/cm².

5. A method as claimed in any one of claims 1 to 4, wherein a temperature of the solution of lupin protein is maintained below about 35° C. when subjected to ultrasound waves.

6. A method as claimed in any one of claims 1 to 5, wherein the solution of lupin protein is subjected to ultrasound waves for a period of 60 minutes or less.

7. A method as claimed in any one of claims 1 to 6, wherein the solution of lupin protein has a protein concentration of about 10% (w/w).

8. A method as claimed in any one of claims 1 to 7, wherein solids that are used to form the solution of lupin protein have a lupin protein content>35%, such as >60%.

9. A method as claimed in any one of claims 1 to 8, wherein the solution of lupin protein has a pH of approximately 7.0 when subjected to ultrasound waves.

10. A method as claimed in any one of claims 1 to 9, further comprising a purification step to purify the solution of lupin protein and/or to purify the modified lupin protein.

11. A method as claimed in any one of claims 1 to 10, wherein after forming the modified lupin protein, the method further comprises:
adjusting a pH of a solution comprising the modified lupin protein to an isoelectric point of the modified lupin protein; and
heating the solution comprising the modified lupin protein to a temperature to induce aggregation of the modified lupin protein and then cooling the solution comprising the modified lupin protein to form a gel.

12. A method as claimed in claim 11, wherein the isoelectric point is approximately pH 4.5.

13. A method as claimed in claim 11 or 12, wherein the solution comprising the modified lupin protein is heated above 70° C.

14. A method as claimed in any one of claims 11 to 13, wherein the solution comprising the modified lupin protein is maintained at the temperature to induce aggregation of the modified lupin for 60 minutes or less.

15. A method as claimed in any one of claims 11 to 14, wherein, after heating the solution comprising the modified lupin to the temperature to induce aggregation, the solution comprising the modified lupin protein is cooled to room temperature to form the gel.

16. A method as claimed in any one of claims 11 to 15, further comprising forming a solution of modified lupin protein prior to adjusting the pH of the solution comprising the modified lupin protein to the isoelectric point of the modified lupin protein.

17. A method as claimed in any one of claims 1 to 10 or claim 16, wherein the modified lupin protein is collected as a powder.

18. A method as claimed in any one of claims 1 to 17, wherein the modified lupin protein is collected as a modified lupin protein concentrate or isolate.

19. A protein feedstock comprising modified lupin protein prepared using the method as claimed in any one of claims 1 to 18.

20. A protein feedstock comprising modified lupin protein, the modified lupin protein having a decreased thermal stability compared to unmodified lupin protein, wherein the modified lupin protein is formed by subjecting unmodified lupin protein to ultrasound waves.

21. A protein feedstock as claimed in claim 20, wherein the modified lupin protein has an increased proportion of β-sheets compared to unmodified lupin protein.

22. A protein feedstock as claimed in claim 20 or 21, having a purity of modified lupin protein>65%.

23. A protein feedstock as claimed in claim 22, wherein the purity is >70%.

24. A protein feedstock as claimed in claim 22 or 23, wherein the modified lupin protein is a concentrate or isolate.

25. A protein feedstock as claimed in any one of claims 20 to 24, wherein the protein feedstock is in the form of a powder.

26. A protein feedstock as claimed in any one of claims 11 to 24, wherein the protein feedstock is in the form of a gel.

27. A protein feedstock as claimed in claim 26, wherein the gel has a Bloom number ranging from about 20 to about 220.

28. A protein feedstock as claimed in claim 26 or 27, wherein the gel has a water holding capacity ranging from about 20% to about 75%.

29. A protein feedstock as claimed in any one of claims 26 to 28, wherein the gel is a cold-set gel.

30. A composition comprising the protein feedstock as claimed in any one of claims 19 to 29.

31. A food product comprising the protein feedstock as claimed in any one of claims 19 to 29.
